(19) United States
(12) Patent Application Publication
(10) Pub. No.: US 2021/0114943 A1
(43) Pub. Date: Apr. 22, 2021

(54) Curing Cementitious Products

(71) Applicant: Saudi Arabian Oil Company, Dhahran (SA)

(72) Inventors: Issam T. Amr, Dhahran (SA); Ahmad D. Hammad, Dhahran (SA); Bandar Fadhel, Dhahran (SA)

(73) Assignee: Saudi Arabian Oil Company, Dhahran (SA)

(21) Appl. No.: 16/696,952

(22) Filed: Nov. 26, 2019

(30) Foreign Application Priority Data
Oct. 16, 2019 (GR) 20190100459

(51) Int. Cl. C04B 40/02; B28B 11/24

(52) U.S. Cl. CPC C04B 40/0231; B28B 11/245; C04B 40/0263; C04B 40/0281; C04B 40/0259; C04B 40/024

(57) ABSTRACT

Systems and method for curing cementitious products are provided herein. In an example, a pressurized water saturator is used to create a CO₂/H₂O stream. The pressurized water saturator includes a carbon dioxide injection line disposed below a water level in the pressurized water saturator, an exit line disposed above the water level in the pressurized water saturator, and a pressure controller configured to hold a positive pressure of carbon dioxide in the pressurized water saturator.

### TECHNICAL FIELD

The present disclosure relates to curing cementitious products.

Specifically, a pressurized water saturator is used to produce a carbon dioxide/water stream to be used as a curing agent for cement mixtures.

### BACKGROUND

Precast cementitious products, such as concrete blocks, concrete steps, roadway forms, and the like, may be produced by forming a desired shape using a mold followed by curing. The concrete mixture may include a cementitious binder, sand, aggregate, and water. As described herein, cementitious binders may include Portland cement or pozzolana cement, among many others.

The concrete mixture is typically flowed from a hopper into a product mold to form a desired shape. After hardening, the shape is extracted from the mold and allowed to cure, for example, by exposure to air for seven to 30 days.

Accelerated curing may be used to increase the productivity of manufacturing cementitious products. Accelerated curing typically involves placing a cementitious product in an enclosure or chamber, and controlling the temperature and relative humidity in the curing chamber. For example, the cementitious products may be placed in the curing chamber for about 8 to about 48 hours. However, energy requirements for accelerated curing may be cost prohibitive.

### SUMMARY

An embodiment described herein provides a method for curing a precast shape. The method includes injecting a carbon dioxide (CO₂) stream into a pressurized water saturator, removing a carbon dioxide/water (CO₂/H₂O) stream from the pressurized water saturator, and flowing the CO₂/H₂O stream from the pressurized water saturator into a curing chamber.

In an aspect, the CO₂/H₂O stream is removed from the pressurized water saturator as a gaseous stream. In an aspect, the CO₂/H₂O stream is removed from the pressurized water saturator as a liquid stream. The liquid may be sprayed over the precast shape in the curing chamber. A sidestream of carbon dioxide may be flowed into the curing chamber.

In an aspect, the method includes controlling a pressure of the pressurized water saturator. In an aspect, the method includes controlling a temperature of the pressurized water saturator. In an aspect, the method includes controlling a flow rate of CO₂ into the pressurized water saturator. In an aspect, the method includes controlling a pressure of the curing chamber. In an aspect, the method includes controlling humidity in the curing chamber.

Another embodiment provides an apparatus for curing a precast cementitious product. The apparatus includes a pressurized water saturator that includes a carbon dioxide injection line disposed below a water level in the pressurized water saturator, an exit line disposed in the pressurized water saturator, and a pressure controller configured to hold a positive pressure of carbon dioxide in the pressurized water saturator. The apparatus includes curing chamber coupled to the exit line of the pressurized water saturator.

In an aspect, the apparatus includes a carbon dioxide line coupled directly to the curing chamber. In an aspect, the apparatus includes a heater on the pressurized water saturator configured to maintain a temperature. The heater may include a steam jacket around the pressurized water saturator.

In an aspect, the apparatus includes a level controller in the pressurized water saturator configured to maintain a water level in the pressurized water saturator. In an aspect, the curing chamber comprises a pressure vessel. In an aspect, the pressure vessel comprises a pressure controller.

Another embodiment described herein provides a pressurized water saturator for creating a CO₂/H₂O stream. The pressurized water saturator includes a carbon dioxide injection line disposed below a water level in the pressurized water saturator, an exit line disposed above the water level in the pressurized water saturator, and a pressure controller configured to hold a positive pressure of carbon dioxide in the pressurized water saturator.

In an aspect, the CO₂/H₂O stream is a liquid stream comprising CO₂ dissolved in H2O. In an aspect, the CO₂/H₂O stream is a gaseous stream comprising CO₂ saturated with water vapor. The exit line may be coupled to a cement mixer, wherein the exit line is configured to inject the CO₂/H₂O stream into a cement mix in the cement mixer.

### BRIEF DESCRIPTION OF DRAWINGS

FIG. 1 is a schematic diagram of a process for accelerating the curing of precast shapes using a pressurized water saturator.

FIG. 2 is a process flow diagram of a method for the accelerated curing of a cementitious product using a pressurized water saturator.

FIGS. 3A and 3B are simplified process flow diagrams of a pressurized water saturator and curing chamber.

FIG. 4 is a plot of the solubility of carbon dioxide (CO₂) in water versus temperature at various pressures.

### DETAILED DESCRIPTION

Curing of cementitious products, termed “precast shapes” herein, is a major step in the production process. Precast shapes may include concrete blocks, concrete bricks, roadway items, such as bridge assemblies and barricades, and many other types of items. Curing is performed in the presence of water to harden the precast shapes as they are converted from a slurry to a solid. The water may be provided by humidity in the atmosphere or by spraying water onto the cementitious products. In some processes, the precast shapes may be placed in a sealed environment, such as a curing chamber, to allow water to be provided by a water spray, adding humidified air, or through the addition of steam. However, the process requires a substantial period of time before the cementitious product reaches the desired strength.

The use of CO₂ for curing precast shapes, and other cementitious products, has been found to enhance the mechanical strength of the precast shapes, for example, compared to normal curing in humid air. The simultaneous addition of steam and carbon dioxide to a curing chamber containing the precast shapes was determined to accelerate the curing and increased the total strength. The addition of the CO₂ enhanced the carbonation in the surface of the cement and hence decreased the time required to reach a desired mechanical strength of the product, for example, allowing earlier shipping, as well as enhanced the final mechanical strength achieved in the product. Technically, the carbonation process controls the heat of hydration through consumption of the produced calcium hydroxide which results in more stable cement paste with higher mechanical strength and higher CO₂ uptake.

Embodiments described herein utilize a pressurized water saturator to dissolve carbon dioxide in water, or saturate CO₂ with water vapor, forming a CO₂/H₂O stream. The CO₂/H₂O stream may be used to simultaneously introduce water and CO₂ into a cement mixture or a curing chamber. Although the techniques are described herein as using the saturated vapor from the pressurized water saturator in a curing chamber, it may be understood that other embodiments may use the pressurized water saturator. For example, the CO₂/H₂O stream may be added to a concrete mix, such as in a concrete mixer or a concrete mixing drum, to treat the cement mix and start the reaction process. The treated concrete mix may then added to mold to form the precast shapes or used in a traditional concrete pour.

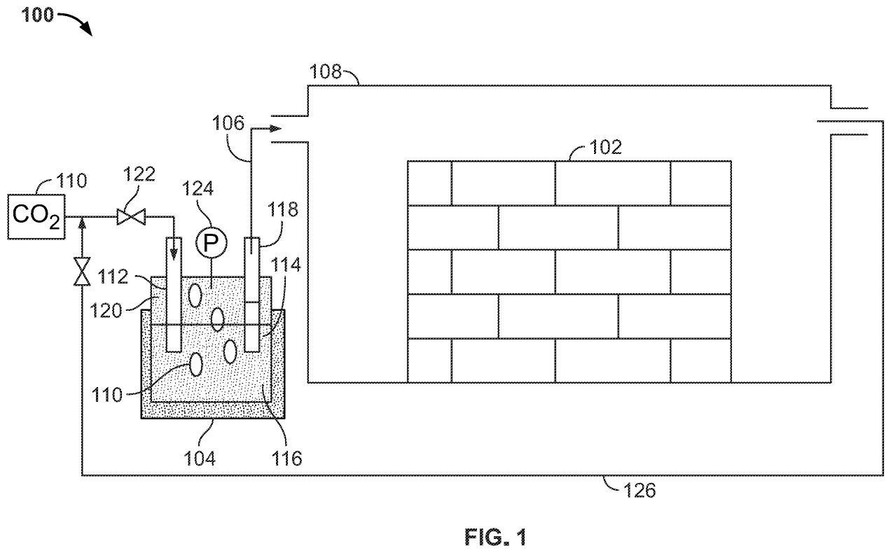

FIG. 1 is a schematic diagram of a process 100 for accelerating the curing of precast shapes 102 using a pressurized water saturator 104. In the process 100, a CO₂/H₂O stream 106 is introduced to the curing chamber 108, or to a cement mixer, from the pressurized water saturator 104.

In the pressurized water saturator 104, CO₂ 110 is injected through an inlet line 112 that is located under the surface 114 of the water 116 in the pressurized water saturator 104. Co-incorporation of the CO₂ 110 and the water 116 into the CO₂/H₂O stream 106 encompasses a number of processes. The CO₂ 110 may be dissolved into the water 116 and physically carried out of the pressurized water saturator 104 with the water 116 through an outlet line 118, for example, if the outlet line 118 is placed below the surface 114 of the water 116 in the pressurized water saturator 104. In these embodiments, the CO₂/H₂O stream 106 is a liquid stream, and may be used to make up at least a portion of the water used to form the concrete mix. The CO₂/H₂O stream 106 may include entrained bubbles of the CO₂ 110, for example, depending on the pressure of the curing chamber 108.

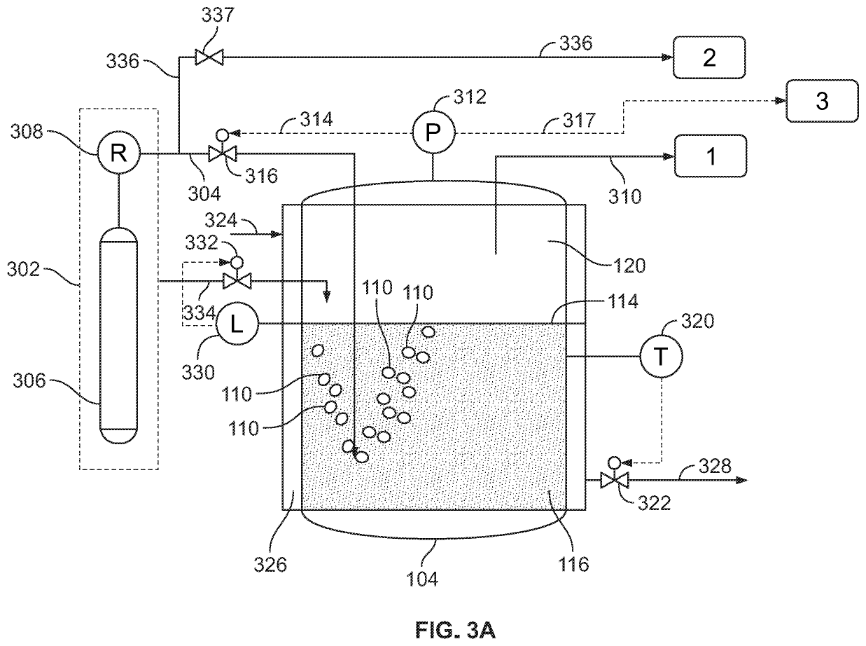

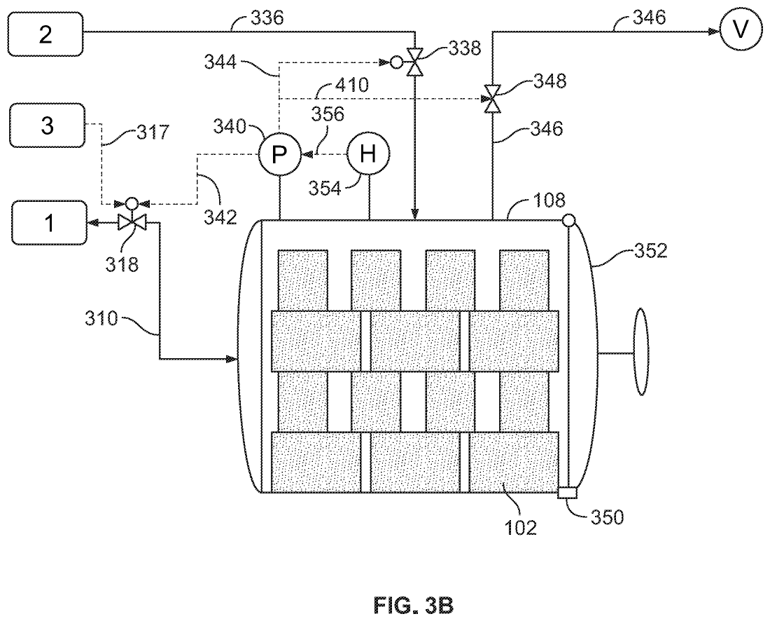

The amount of CO₂ incorporated into the water 116 in the pressurized water saturator 104, and the physics of the incorporation, physical or chemical, are determined by controlling the flow rate, pressure, and temperature in the pressurized water saturator 104. The flow rate may be controlled by a valve 122 on the inlet line 112. A pressure controller 124 may be used to control the pressure of the CO₂ 110 in the headspace 120, as discussed further with respect to FIGS. 3 and 5. The pressure of the curing chamber 108 may also be controlled to maintain the CO₂/H₂O stream 106 until it reaches the curing chamber 108, or to allow for a higher partial pressure of CO₂ 110.

In some embodiments, the outlet line 118 is located in the headspace 120 of the pressurized water saturator 104. In these embodiments, the CO₂/H₂O stream 106 is a gaseous stream that may be used to introduce CO₂ and water into the atmosphere of the curing chamber 108. The amount of water vapor entrained into the CO₂ is controlled by the flow rate, pressure, and temperature in the pressurized water saturator 104.

In some embodiments, an additional CO₂ stream 126 is introduced into the curing chamber 108. In these embodiments, the additional CO₂ stream 126 allows for a higher concentration or pressure of CO₂ 110 in the curing chamber 108.

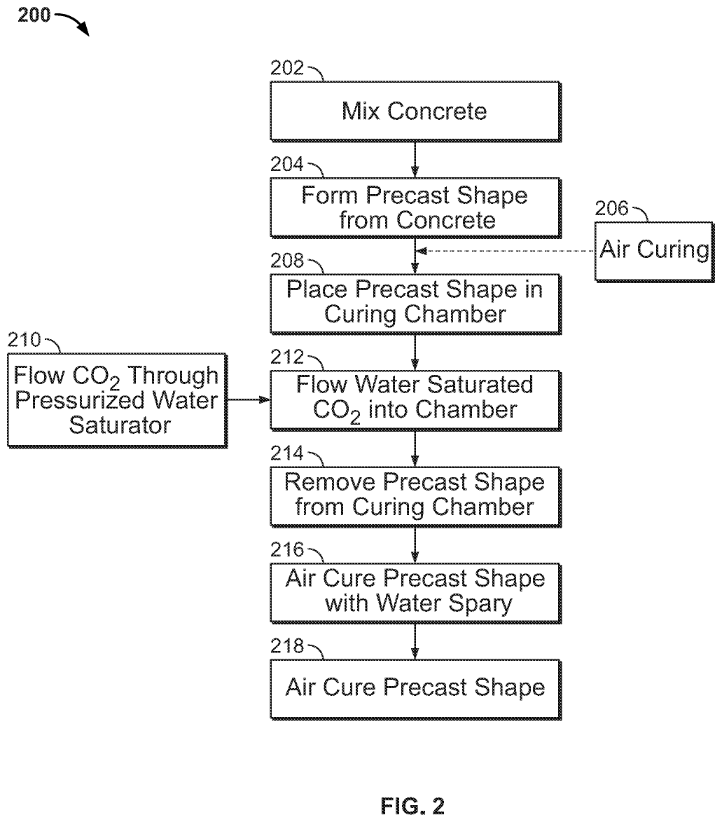

FIG. 2 is a process flow diagram of a method 200 for the accelerated curing of a shaped article using a pressurized water saturator. As described with respect to FIG. 1, a CO₂/H₂O stream is injected into a curing chamber that holds precast shapes. The CO₂ and water react with compounds in the cement of the precast shapes, such as tricalcium silicate, to form calcium hydroxide and calcium carbonate. Further, the CO₂ may react with calcium hydroxide formed during the curing of the precast shapes to form calcium carbonate, sequestering CO₂ in the precast shapes. The amount of calcium hydroxide formed during early stages of curing is regulated such that the heat of hydration within the precast shapes is reduced compared to curing without CO₂. This may result in less thermal expansion of the precast shapes during the early stages of curing, leading to a reduction in micro cracks, resulting in an increase of strength for the precast shapes.

At block 202, the concrete is mixed. As used herein, the term “concrete” refers to a mixture of a cement binder, aggregate, and water. The cement binder may be a Portland cement binder containing tricalcium silicate (Ca₃SiO₅ or 3CaO), dicalcium silicate (Ca₂SiO₄ or 2CaO.SiO), tricalcium aluminate (Ca₃Al2O₆ or 3CaO.Al₂O₃.Fe₂O₃), tetracalcium aluminoferrite (Ca₄Al₂Fe₂O₁₀ or 4CaO.Al₂O₃Fe₂O₃), or gypsum (CaSO₄.2H₂O), or any combinations thereof. One example of a composition of a Portland cement binder is provided in Table 1.

TABLE 1
Exemplary composition for Portland cement binder

| Compound | Weight Percent |
|---|---|
| tricalcium silicate | 50 |
| dicalcium silicate | 25 |
| tricalcium aluminate | 10 |
| tetracalcium aluminoferrite | 10 |
| Gypsum | 5 |

Although Table 1 provides an example of a Portland cement binder, the use of the pressurized water saturator is not limited to this. Any number of other cement binders may be used in embodiments, including rapid hardening cement binders, low heat cement binders, sulfate resisting cement binders, white cement binders, pozzolanic cement binders, hydrophobic cement binders, colored cement binders, waterproof cement binders, blast furnace cement binders, air entrainment cement binders, high alumina cement binders, and expanding cement binders, among others.

The aggregate that is combined with the cement binder may include chemically inert and solid bodies. The aggregate may have various shapes and sizes, and may be made from various materials ranging from fine particles of sand to large rocks. The aggregate may include ultra-light aggregate, lightweight aggregate, normal-weight aggregate, and heavy-weight aggregate. Non-limiting examples of ultra-light weight aggregate include vermiculite, ceramics spheres, and perlite. Light-weight aggregate may include expanded clay, shale or slate, or crushed brick. Normal-weight aggregate may include crushed limestone, sand, river gravel, or crushed recycled concrete. Heavy-weight aggregate may include steel or iron shot, or steel or iron pellets.

In addition to the cement binder, aggregate and water, other additives may be added to a concrete mixture to increase the durability, workability, strength, and other properties, of a concrete mixture or a precast shape formed from the concrete mixture. For example, air entraining additives in the form of detergents may be added to concrete mixtures to improve durability and workability of the concrete mixture. Plasticizing additives, such as polymers, may be added to increase the strength of the precast shape by decreasing the amount of water needed for workable concrete. Retarding additives, such as sucrose, may be used to delay setting times of a concrete mixture and increase long term strength of the precast shape. Alternatively, accelerating additives, such as calcium chloride, may be added to speed setting time of a concrete mixture and improve early strength of a precast shape. Mineral additives, such as fly ash, may be added to improve workability, plasticity, and strength. Pigments, such as metal oxides, may be added to provide color to a precast shape.

At block 204, the concrete mixture is poured into a mold to form a precast shape. Non-limiting examples of molds and precast shapes include blocks, stairs, countertops, pre-fabricated concrete walls, and the like. As indicated by block 206, the precast shape is allowed to harden through air curing prior to being removed from the mold, for example, for about 1 hour to about 8 hours. After removal from the mold, the precast shape may be allowed to have further curing time in the air.

At block 208, the shaped article is placed within the curing chamber. The temperature within the curing chamber may be controlled to adjust the curing time, in addition to other variables, such as CO₂, relative humidity, and pressure. The use of the pressurized water saturator may allow lower temperatures to be used in the curing chamber. The curing temperature may be between about 40° C. and about 80° C., or between about 50° C. and about 70° C., or between about 55° C. and about 65° C. The use of the pressurized water saturator may allow lower curing temperatures to be used. The relative humidity in the curing chamber may also be controlled. For example, the humidity in the curing chamber may be between about 40% and about 80%, or about 50% and about 70%, or about 55% and about 65%.

At block 210, CO₂ is injected into the water in the pressurized water saturator. As described herein, in some embodiments, the CO₂ is saturated with water vapor in the pressurized water saturator prior to being flowed into the curing chamber at block 212. In other embodiments, CO₂ is dissolved into water, and a water spray with the dissolved CO₂ is flowed into the curing chamber at block 212. As described herein, in some embodiments an extra CO₂ stream, or sidestream, is flowed into the curing chamber, for example, to increase the amount of CO₂ in the curing chamber when a water spray from the pressurized water saturator is used.

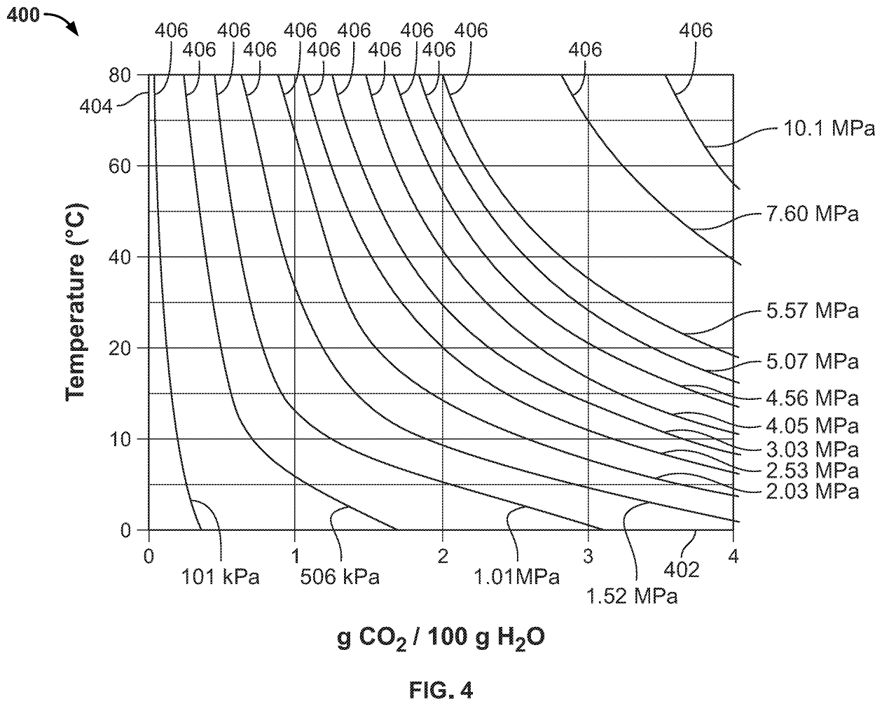

In embodiments in which the CO₂/H₂O stream is a liquid stream, the amount of CO₂ dissolved in the water stream may be dependent on the pressure of the pressurized water saturator. For example, at a temperature of about 10° C. and a pressure of about 70 psi the amount of CO₂ dissolved in the water stream is about 1 weight %. This is discussed further with respect to FIG. 4.

In some embodiments, the CO₂/H₂O stream is introduced into a curing chamber with the precast shape as a gaseous stream, in which CO₂ is saturated with water vapor. In these embodiments, the concentration of water vapor in the saturated CO₂/H₂O stream is determined by the flow rate, pressure, and temperature in the pressurized water saturator. For example, the concentration of CO₂ may be between about 60 vol. % and about 95 vol. %, between about 70 vol. % and 95 vol. %, and about 80 vol. % and about 95 vol. %.

The shaped article is allowed to cure within the curing chamber for a duration of between about 2 hours and about 24 hours. In some examples the shaped article may be cured in the curing chamber for a duration of between about 4 hours and about 16 hours, between about 6 hours and about 12 hours, or about 8 hours.

During curing, the CO₂ permeates the shaped article and reacts with the cement binder to form calcium hydroxide and calcium carbonate. Generally, this provides two benefits, the strength of the shaped article is increased by the reaction, and CO₂ is sequestered in the shaped article. The shaped article may have a CO₂ uptake, in weight percent (wt. %), greater than or equal to about 15 wt. %, greater than or equal to about 20 wt. %, or greater than or equal to about 25 wt. %. Further, during curing, water reacts with and hydrates the compounds of the cement binder. Hydration of calcium silicates in the cement binder increases the strength of the shaped article. For example, hydration of the tricalcium silicate may be responsible for most of the strength developed within the first seven days of curing and hydration of the dicalcium silicate may be responsible for strength obtained at longer durations. Hydration of the tricalcium silicate occurs via the chemical reaction shown in Equation 1.

2Ca₃SiO₅(s)+7H₂O(I)→3CaO.2SiO₂.4H₂O(s)+3Ca(OH)₂(s) (1)

Hydration of the dicalcium silicate occurs via the chemical reaction shown in Equation 2.

2Ca3SiO₄(s)+5H₂O(I)→3CaO.2SiO₂.4H₂O(s)+Ca(OH)₂(s) (2)

In addition to the reaction with the calcium silicates, the calcium hydroxide formed by the reaction of the calcium silicates with water may be converted to calcium carbonate via the reaction shown in Equation 3.

Ca(OH)₂(s)+CO₂(g)→CaCO₃(s)+H₂O(I) (3)

As described herein, the reaction of the CO₂ with the calcium hydroxide to form calcium carbonate increases the strength of the shaped article. Furthermore the reduction of the amount of calcium hydroxide formed may result in a reduction of the heat of hydration within the shaped article. This may result in the last thermal expansion of the shaped article, leading to the formation of fewer microcracks in the shaped article.

At block 214, the precast shape is removed from the curing chamber. The shaped article may be allowed to dry, or may be kept in a water mist during further curing, as indicated at block 216. At block 218, the shaped article is allowed to further cure in the air. This may be a deliberate process in which the shaped article is held for a day, week, or longer, before shipping, or may be coincidental to the shipping of the shaped article to a point of final usage.

FIGS. 3A and 3B are simplified process flow diagrams of a pressurized water saturator 104 and curing chamber 108. Like numbered items are as described with respect to FIG. 1. As shown in FIG. 3A, a CO₂ source 302 provides a CO₂ stream to a CO₂ feedline 304. In this embodiment, the CO₂ source 302 is a pressurized tank 306 coupled to a pressure regulator 308. In other embodiments, the CO₂ source 302 may be a flue gas stream from a combustion process, for example, used in a power plant to produce electricity. The CO₂ source 302 may be a cryogenic storage tank using a heat exchanger to provide the CO₂ gas.

As described herein, any one, or all, of the pressure, temperature, and CO₂ flow rate in the pressurized water saturator 104 are controlled to control the amount of CO₂ and water in the CO₂/H₂O stream removed from the pressurized water saturator 104 through an exit line 310. Further, in some embodiments, the level of the water 116 in the pressurized water saturator 104 is controlled to replace the water 116 as it is removed from the pressurized water saturator 104 through vapor flow or liquid flow.

In the embodiment shown in FIG. 3, the pressure in the pressurized water saturator 104 is controlled by a pressure controller 312 that has a sensor located in the pressurized water saturator 104, and a control line 314 coupled to a CO₂ pressure control valve 316. The pressure controller 312 may also have a second control line 317 coupled to an outlet pressure control valve 318 on the exit line 310, as shown in FIG. 3B. The CO₂ pressure control valve 316 controls the flow rate of the CO₂ 110, which is injected below the surface 114 of the water 116. In this embodiment, the exit line 310 is placed above the surface 114 of the water 116, to allow CO₂ that has been saturated with water vapor to exit through the outlet line 118.

In the embodiment shown in FIG. 3, the temperature in the pressurized water saturator 104 is controlled by a temperature controller 320. The temperature controller 320 has a sensor located in the water 116, and controls a steam flow valve 322 that allows steam to flow from a steam inlet line 324 through a jacket 326 and out a steam output line 328. The temperature control is not limited to the use of steam, but may use other heat exchange fluids. For example, hot oil, hot water, or other fluids may be used to heat the contents of the pressurized water saturator 104. Further, the temperature control does not need to utilize located a jacket 326, but may use coils located in the water 116.

The CO₂ flow rate through the pressurized water saturator 104 may be controlled by the adjustment of the CO₂ pressure control valve 316 and the outlet pressure control valve 318. While the pressure may be maintained by controlling the relative adjustment of these two valves 316 and 318, opening both valves proportionally higher may allow higher flow through the pressurized water saturator 104.

The level of the water 116 in the pressurized water saturator 104 may also be control. As shown in the embodiment of FIG. 3A, a level controller 330 as a level sensor located in the interior of the pressurized water saturator 104, for example, at or near a desired control level for the water 116. The level controller 330 controls a water valve 332 that allows water to flow in from a water line 334. In some embodiments, the level controller 330 is not utilized, for example, when CO₂ is flowed into the water 116 and removed as a water saturated gas stream. In these embodiments, the initial addition of the water 116 may be sufficient during curing.

A CO₂ line 336 may allow the addition of a slipstream of CO₂ from the CO₂ source 302 directly to the curing chamber 108. For example, a valve 337 may allow flow of CO₂ from the CO₂ source 302 to reach a CO₂ pressure control valve 338, which may be used by a curing chamber pressure controller 340 to control the pressure, or the addition of CO₂, to the curing chamber 108.

FIG. 3B is a simplified process flow diagram of a curing chamber 108 for precast shapes 102 that uses a pressurized water saturator 104 to generate a CO₂/H₂O stream for addition to the curing chamber 108. Like numbered items are as described with respect to FIG. 1. The curing chamber pressure controller 340 may also have a control line 342 coupled to the outlet pressure control valve 318. In some embodiments, a unified control system may control pressure in both the pressurized water saturator 104 and the curing chamber 108. The curing chamber pressure controller 340 may also have a control line 344 link to the CO₂ pressure control valve 338 to adjust the amount of CO₂, and the effect of the CO₂ on pressure in the curing chamber 108, coming from the CO₂ line 336. A vent line 346 allows the pressure in the curing chamber 108 to be reduced through a vent valve 348 that is linked by a control line 410 to the curing chamber pressure controller 340. The vent valve 348 also allows the pressure in the curing chamber 108 to be released, so that a lock 350 on a hatch 352 on the curing chamber 108 may be released to allow the curing chamber 108 to be opened, for example, so that precast shapes 102 may be placed in the curing chamber 108 or removed from the curing chamber 108.

In some embodiments, the humidity in the curing chamber 108 is controlled. For example, in the embodiment shown in FIG. 3B, a humidity sensor 354 is coupled to the curing chamber pressure controller 340 through a sensor line 356. The curing chamber pressure controller 340 may use the measurement from the humidity sensor 354 to adjust the ratio of the CO₂/H₂O stream from exit line 310 with the CO₂ stream from the CO₂ line 336 in order to control the humidity in the curing chamber 108.

FIG. 4 is a plot 400 of the solubility of CO₂ 402 in water versus temperature 404 at various pressures 406. For example, to solubilize CO₂ in water, FIG. 4 indicates the amount of CO₂ in grams that could be dissolved in 100 g of water at a given temperature and pressure. The solubility of a gas in a liquid is defined by Henry's law, which states that at a constant temperature, the concentration of the gas that is dissolved in a given liquid is proportional a partial pressure of the gas above the liquid. Henry's law may be expressed by the formula shown in equation 4.

H^{cp}=^{c}^{_{aq}}/p (4)

In equation 4, H^{cp} is Henry's constant for the particular gas involved, c_{aq} is the concentration of the gas in the liquid, and ρ is the partial pressure of the gas over the liquid. For CO₂, the value of H^{cp} is about 29 at standard temperature (298.15 K) and pressure (1 atm, 101 kPa). When the temperature of the system changes Henry's coefficient also changes. This may be generally expressed by the van't Hoff equation shown in equation 5.

$$H ( T ) = {H}^{o} \times exp [ \frac{- {Δ}_{s o l} H}{R} ( \frac{1}{T} - \frac{1}{{T}^{o}} ) ] \qquad ( 5 )$$

In equation 5, ΔₛₒₗH represents the enthalpy of dissolution, R is the ideal gas constant, H^{o} is Henry's constant at standard temperature and pressure, i.e., H^{cp}, and T^{o} is 298.15 K (standard temperature). This may be used to generate the curves shown in the plot of FIG. 4. As shown in the curves of FIG. 4, a higher partial pressure of CO₂ and a lower temperature provides a higher solubility of CO₂ in water.

As described herein, CO₂ in water can exist in either gaseous state or as carbonic acid. Both of these forms can participate in curing cementitious products through reactions shown in equations 5 and 6.

Ca(OH)₂(s)+CO₂(g)→CaCO₃(s)+H₂O(I) (5)

CaO(s)+H₂CO₃(aq)→CaCO₃(s)+H₂O(I) (6)

These reaction schemes are further enhanced by the increase of temperature due to heat of hydration in the curing chamber. In the techniques described herein, gaseous CO₂ may be introduced into the curing chamber as a gas, or carried into the curing chamber dissolved in a liquid. As the temperature of the precast shape increases during curing, the CO₂ is released from the water within the concrete mixture, consequently lead to curing enhancement. Therefore, the techniques provide the ability to in-situ control CO₂ percentage/concentration that participate in the curing process by individually or collectively controlling temperature, vapor pressure, and flow rate of CO₂.

Further, the injection of CO₂ using the pressurized water saturator is expected to reduce the resistance of the three phase boundary, which facilitates the curing surface reactions. It is also expected that the proposed curing method would consume lower energy in comparison to its conventional steam curing counterpart, since there is no need for steam generation.

Other implementations are also within the scope of the following claims.

What is claimed is:

1. A method for curing a precast shape, comprising:
injecting a carbon dioxide (CO₂) stream into a pressurized water saturator;
removing a carbon dioxide/water (CO₂/H₂O) stream from the pressurized water saturator; and
flowing the CO₂/H₂O stream from the pressurized water saturator into a curing chamber.

2. The method of claim 1, wherein the CO₂/H₂O stream is removed from the pressurized water saturator as a gaseous stream.

3. The method of claim 1, wherein the CO₂/H₂O stream is removed from the pressurized water saturator as a liquid stream.

4. The method of claim 3, wherein the CO₂/H₂O stream is sprayed over the precast shape in the curing chamber.

5. The method of claim 1, comprising flowing a sidestream of carbon dioxide into the curing chamber.

6. The method of claim 1, comprising controlling a pressure of the pressurized water saturator.

7. The method of claim 1, comprising controlling a temperature of the pressurized water saturator.

8. The method of claim 1, comprising controlling a flow rate of CO₂ into the pressurized water saturator.

9. The method of claim 1, comprising controlling a pressure of the curing chamber.

10. The method of claim 1, comprising controlling humidity in the curing chamber.

11. An apparatus for curing a precast cementitious product, comprising:
a pressurized water saturator, comprising:
a carbon dioxide injection line disposed below a water level in the pressurized water saturator;
an exit line disposed in the pressurized water saturator; and
a pressure controller configured to hold a positive pressure of carbon dioxide in the pressurized water saturator; and
a curing chamber coupled to the exit line of the pressurized water saturator.

12. The apparatus of claim 11, comprising a carbon dioxide line coupled directly to the curing chamber.

13. The apparatus of claim 11, comprising a heater on the pressurized water saturator configured to maintain a temperature.

14. The apparatus of claim 13, wherein the heater comprises a steam jacket around the pressurized water saturator.

15. The apparatus of claim 11, comprising a level controller in the pressurized water saturator configured to maintain the water level in the pressurized water saturator.

16. The apparatus of claim 11, where the curing chamber comprises a pressure vessel.

17. The apparatus of claim 16, wherein the pressure vessel comprises the pressure controller.

18. A pressurized water saturator for creating a CO₂/H₂O stream, comprising:
a carbon dioxide injection line disposed below a water level in the pressurized water saturator;
an exit line disposed above the water level in the pressurized water saturator; and
a pressure controller configured to hold a positive pressure of carbon dioxide in the pressurized water saturator.

19. The pressurized water saturator of claim 18, wherein the CO₂/H₂O stream is a liquid stream comprising CO₂ dissolved in H₂O.

20. The pressurized water saturator of claim 18, wherein the CO₂/H₂O stream is a gaseous stream comprising CO₂ saturated with water vapor.

21. The pressurized water saturator of claim 18 wherein the exit line is coupled to a cement mixer, and wherein the exit line is configured to inject the CO₂/H₂O stream into the cement mix in the cement mixer.
